(19) United States
(12) Patent Application Publication
(10) Pub. No.: US 2003/0070356 A1
(43) Pub. Date: Apr. 17, 2003

(54) Planting pot from reproductive material

(76) Inventors: Albert Wibmer, Reutlingen (DE); Reinhold Walz, Holzgerlingen (DE)

Correspondence Address: Law Offices Renner, Otto Boisselle & Sklar, 19th Floor The Keith Bldg, 1621 Euclid Avenue, Cleveland, OH, 44115-2191, US

(21) Appl. No.: 09/980,067

(22) PCT Filed: May 1, 2001
(86) PCT No.: PCT/EP01/02290

(30) Foreign Application Priority Data
Apr. 28, 2000 (DE) 200 07 750.3
Apr. 28, 2000 (DE) 200 07 748.1

(51) Int. Cl. A01G 9/02

(52) U.S. Cl. 47/65.7

(57) ABSTRACT

The invention relates to a planting pot with a conical outer surface, bottom and shaped rim on the pot opening. The aim of the invention is to provide a method for producing such a planting pot from a blank that can be produced without material loss. To this end, a conical blank produced from a single rectangular unwound section is transversely cut from a larger, web-shaped flat structure that has two parallel straight web edges (10, 12). The blank has two identical arched separating edges (14, 16), and the outer edge of the two straight longitudinal edges (12) of the ribbon section is glued. The invention further relates to a planting pot with an inverted dome shaped bottom (22) from the tapered end of the blank shaped using heat and pressure, and with a flange-type edge (24) from the widening end of the blank shaped using heat and pressure.

### DESCRIPTION

The invention concerns a planter made of renewable organic material, with a cone-shaped shell made from a blank, a bottom, and a shaped rim at the opening of the planter.

With a planter of this type, previously known from DE 42 34 737 A1 (Wibmer), its flat bottom and the ring-shaped shell attached to it are formed separately, are assembled in overlapping fashion, and are bonded to each other by means of an adhesive in the area of overlap. In manufacturing a planter of this type from two separate parts, the flat developments of the bottom and/or the shell are die-cut from the same flat material. This method produces a significant amount of waste for which there is no demand (unless large quantities of waste are produced) despite the fact that an ecologically harmless material is used, such as a (dry) fleece of short flax fibers. The invention addresses the problem of creating a planter that can be manufactured with a minimum of waste.

This problem is solved by the planter described in claim 1, in particular as described in claim 4.

Since the web of material has parallel edges, and because the crosswise cutting of an xth (x>1) blank development from the web produces identical arc-shaped edges at the front edge and the rear edge of the development, with its front edge perfectly matching the rear edge of the preceding development and its rear edge perfectly matching the front edge of the following development, all these developments that are cut from the web of material without any waste are of identical shape.

In the design variant according to claim 5 with a cup-shaped planter bottom, this type of bottom, just like the lateral rim at the planter opening, has the effect of stabilizing the planter shape which makes it possible to safely stand up or pick up the planter proposed by the invention if this planter is to be automatically filled with soil and plants prior to being put outside.

A one-piece planter is known the material of which consists of a deep-drawn dry fleece of coconut fibers, with latex as an impregnating fiber binding agent. However, the manufacture of such a planter whose material can barely be penetrated by the roots and which does not easily decompose in the ground also inevitably produces waste. These disadvantages are avoided specifically by two dig preferred design variants of the planter proposed by the invention whose shell consists of an air-permeable dried wet fleece made primarily from coconut fibers (claim 2), and/or whose bottom consists of a wide-mesh fabric made from jute yarn (claim 3), which means the planters made in this fashion have distinctly favorable properties.

For a wide planter whose bottom cannot be formed from the tapering end of the blank because there is not enough shell material for this, unless the length of the shell is to be drastically shortened, claim 6 proposes a separate bottom that is produced in accordance with claim 7 and may be connected to said end of the shell. When heat and pressure are applied to the material, the asymmetrical part of the blank protruding beyond the bottom is pressed against the narrower shell end, preferably its inside, unless it is decided to accept a small amount of waste by cutting off the protruding blank material.—With its corners in particular, the separate bottom stiffens the narrower shell end, due to the fact that they increase the bonding surface; it also makes it possible to manufacture the planter proposed by the invention from different materials for the shell and the bottom, depending on which is the most suitable for each purpose.

The following explains the planter proposed by the invention in detail with the help of two design variants shown in the drawings.

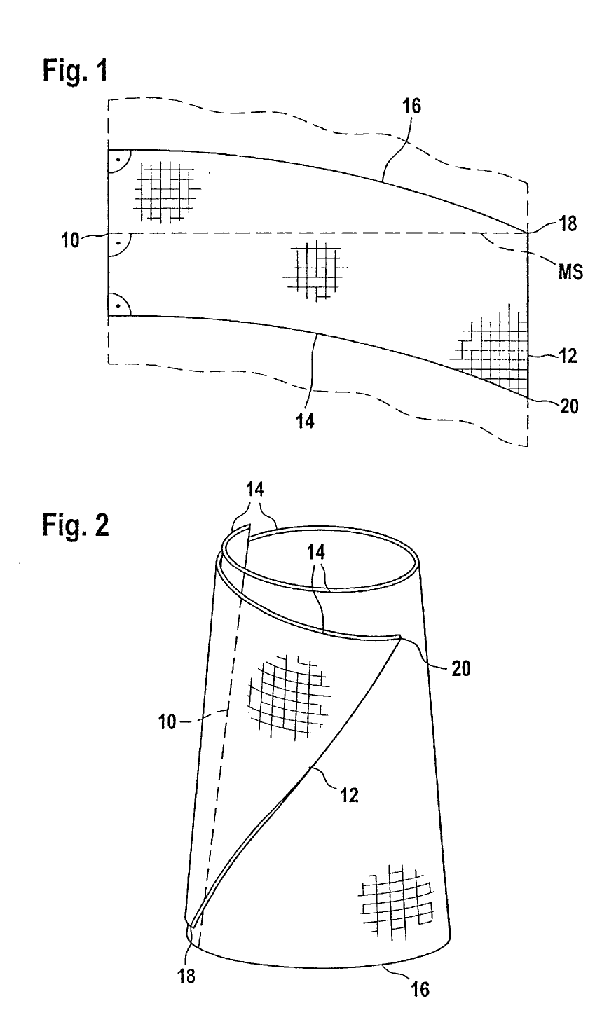

FIG. 1 shows the flat development of the blank of the first design variant

FIG. 2 shows the same perspective view of this blank after it has been rolled up

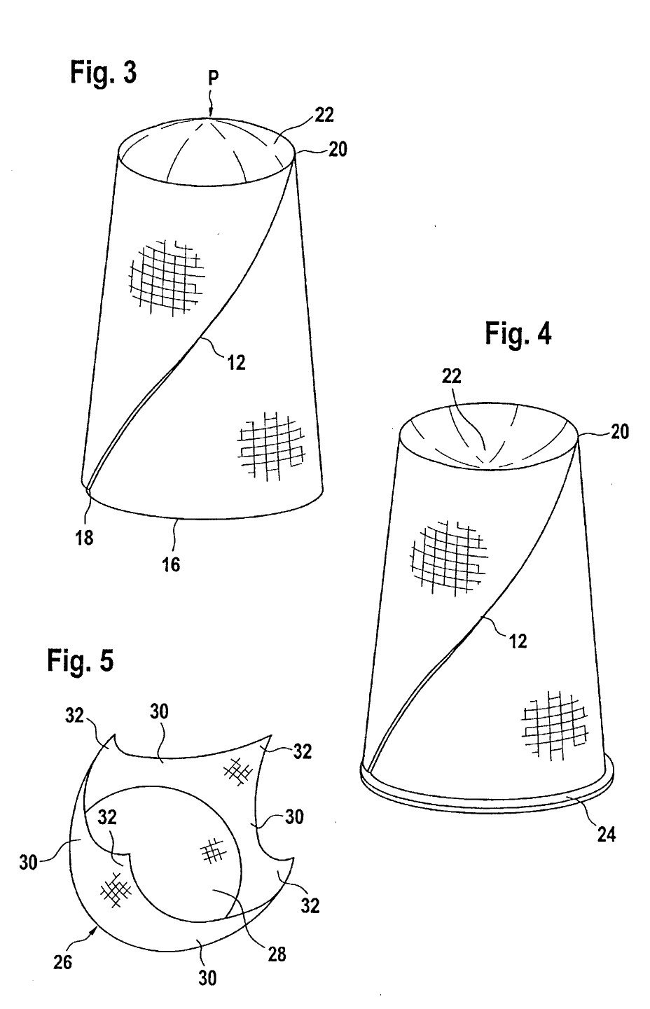

FIG. 3 shows the same perspective view of this blank after a cup has been formed

FIG. 4 shows the same perspective view of the blank after the cup has been inverted and an edge has been formed, and also of the finished planter (first design variant)

FIG. 5 shows a perspective view of the bottom of the second design variant.

The planter proposed by the invention, made of jute fabric according to FIG. 4, is formed from the blank proposed by the invention as shown in FIG. 2, which in turn is made of its flat development shown in FIG. 1; said development has two parallel longitudinal edges of equal length 10 and 12, being sections of the web edges of a web of material shown by the dotted lines in FIG. 1. The development was machine-cut in such a way that two identical shallow-arc-shaped separating edges 14 and 16 were produced, with said edges running crosswise to the longitudinal direction of the web of material, and with each forming a right angle with the longitudinal edge 10; with the other longitudinal edge 12, said shallow-arc-shaped separating edges (14 and 16) form an acute and an obtuse angle, respectively. Here, the obtuse-angle corner 18 of the development (FIG. 1) is located approximately on the median perpendicular MS of the one longitudinal edge 10.

The development in FIG. 1 is rolled up to form a cone-shaped blank as in FIG. 2, in such a way that the longitudinal edge 10 that was cut at right angles from one web edge in the course of two cutting steps is on the inside and runs approximately along a cone-shaped shell directrix, while the other longitudinal edge 12 that was cut from the web at an angle is on the outside, intersecting another cone-shaped shell directrix at an angle of approximately 45°; here, the acute-angle corner 20 of the development (FIG. 1) is on the outside of the blank (FIG. 2), and the edge of the development that is completely exposed is glued along the other longitudinal edge 12 with polyoleofin or some other environmentally harmless adhesive.—Here, the separating edges 14 and 16 do not run along circular lines on parallel planes, but each follows a helix of different lead.

In order to shape the blank (FIG. 2) into the intermediate shape according to FIG. 3, heated press molds are used that form a cup 22 that is concave towards the outside at the tapering end of the blank. At its apex, this cup may have a drain hole. For the final shaping of the blank with cup 22 (FIG. 3), different heated press molds are used that invert the cup 22 under pressure p towards the inside, giving it the appearance of a concave planter bottom. At the same time, at the wide end of the blank, a narrow, flange-type rim 24 is formed, also with heated press molds.

The second design variant differs from the one described first in FIG. 5 by having a different planter bottom 26 that is not shaped from a cup (22) forming one piece with the planter shell (blank according to FIG. 2), but is manufactured separately and is then firmly attached to the shell (blank according to FIG. 2).

Here, the bottom 26 consists of a circular plate 28 from which, due to the effect of heat and pressure on a square flat development, an annular edge has been drawn up. During the same shaping process, four approximately rectangular curved comers (of the development) 32 pointing upward have been shaped in said annular edge in such a way that the annular bottom edge 30 and the corners 32 together were given a cone shape that corresponds to the taper of the tapering end of the shell (blank according to FIG. 2), with the result that the bottom edge fits tightly into this end of the shell. In order to secure the position of the bottom 26, its edge 30 and the comers 32 are glued to the shell (blank according to FIG. 2), with the asymmetrical part of the blank protruding beyond the bottom being pressed against the narrower shell end when heat and pressure are applied to the material.

In this second design variant, the bottom 30 consists, like the shell (blank according to FIG. 2), of an air-permeable dried wet fleece made primarily of coconut fibers during whose manufacture polyvinyl alcohol (PVA) fibers were added as binding agent which, when heat and pressure are applied, bonds the bottom edge 30 and the corners 32 to the tapering shell end, eliminating the need for a special adhesive.

1. Planter (FIG. 4) with a cone-shaped shell, a bottom, and a shaped rim at the planter opening, produced from a cone-shaped blank (FIG. 2) of renewable organic material for making the shell from a single rectangular flat development (FIG. 1) of the blank, where this development is cut crosswise from a larger web-type flat material with two parallel longitudinal edges (10, 12) and has two identical arc-shaped separating edges (14, 16), with the exposed edge (12) of the two straight longitudinal edges of the development being glued.

2. Planter according to claim 1, characterized by the fact that at least the shell consists of an air-permeable dried wet fleece made primarily from coconut fibers.

3. Planter according to claim 1, characterized by the fact that at least the bottom consists of a wide-mesh fabric made of jute yarn.

4. Planter according to any of the claims 1 through 3, characterized by the fact that one of the two straight web edges (10, 12) of the blank (FIG. 2) forms a right angle with both of its arc-shaped edges (14, 16), and that its median perpendicular (MS) passes approximately through the obtuse-angle comer (18).

5. Planter according to any of the claims 1 through 4, with an inverted cup-shaped bottom (22) shaped from the tapering end of the blank through application of heat and pressure, and with a flange-type rim (24) shaped from the widening end of the blank through application of heat and pressure.

6. Planter according to any of the claims 1 through 4, whose separate bottom (26) is made from a single square flat development, cut from a larger piece of flat material, by means of a deformation of the four edges of the development under the influence of heat and pressure. As a consequence, it has a drawn-up annular edge (30) with four approximately rectangular, curved comers (32) pointing upward. The bottom edge (30) and the corners (32) together have the shape of a cone whose shape corresponds to the tapering end of the shell (FIG. 2).

7. Planter according to claim 6 with claim 2, characterized by the fact that the bottom (26) also consists of the wet fleece during whose manufacture the coconut fibers were mixed with polyvinyl alcohol (PVA) fibers serving as a binding agent which, when heat and pressure are applied, bonds the bottom edge (30) along with its corners (32) with the tapering end of the shell when inserted into the same.
